(19) United States
(12) Patent Application Publication
(10) Pub. No.: US 2021/0345621 A1
(43) Pub. Date: Nov. 11, 2021

(54) SCENT NEUTRALIZING FORMULATION AND METHOD OF MAKING AND USING THE SAME

(71) Applicant: Zeev Dorfman, Tarzana, CA (US)

(72) Inventor: Zeev Dorfman, Tarzana, CA (US)

(73) Assignee: Dr Air Care Health Solutions Inc. DBA Rodents Stop, Lake Balboa, CA (US)

(21) Appl. No.: 17/314,022

(22) Filed: May 6, 2021

Related U.S. Application Data
(60) Provisional application No. 63/020,698, filed on May 6, 2020.

(51) Int. Cl. A01N 65/22; A01N 25/04

(52) U.S. Cl. CPC A01N 65/22; A01N 25/22; A01N 25/04

(57) ABSTRACT

Scent neutralization is important on many occasions. Disclosed herein is a nano emulsion formulation that comprises about 1-20 weight percent a scent neutralizing agent, a stabilizer, and a disinfectant in water in the form of a nano emulsion. In one embodiment, the weight ratio between the scent neutralizing agent and the stabilizer is close or equal to one. The nano emulsion formulation can be used to eliminate odor of rodents to prevent its reentry into a treated premise. In one embodiment, a diluted formulation is sprayed to cover the premise followed by reapplying every few weeks. In one embodiment, the nano emulsion formulation is a peppermint formulation.

### FIELD OF THE INVENTION

The present disclosure is directed to formulation and method of scent neutralization and disinfection. In one embodiment, the formulation is a nano emulsion peppermint formulation. The method comprises the step of using the formulation in eliminating odors, for example using the nano emulsion peppermint formulation to eliminate rodent odors.

### BACKGROUND

Disinfecting and scent neutralization are important on many occasions. For example, disinfecting and neutralization of the premises is an important step in the process of eliminating rodents in human dwellings. After rodents are physically removed from an infected area, it is important to additionally treat the previously infected area to further eliminate the odors or pheromone left by the rodents. For instance, by spraying pheromone neutralizer in infected area, the scent trails that lead rodents to human dwellings are eliminated, which is believed to deter the rodents from aggressively attempting to re-enter the treated premises.

Currently commercially available scent neutralization formulations are either not effective or too expensive for its intended purpose. There remains a need for a scent neutralization formulation that is effective and economical.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, formulations. and combinations set forth in the detailed examples discussed below.

### SUMMARY

In a first aspect, provided herein is a peppermint formulation for scent neutralization. The formulation comprises about 1-20 weight percent a scent neutralizing agent comprising peppermint oil, a stabilizer comprising Tween 60 wherein the weight ratio between the peppermint oil and Tween 60 is close or equal to one, and about 5 weight percent disinfectant benzalkonium chloride, in distilled water in the form of a nano emulsion. In one embodiment, the formulation further comprises about 2 weight percent sodium bicarbonate. In one embodiment, the formulation further comprises about 30 weight percent an odor enhancement solvent that comprises peppermint water.

In a second aspect, provided herein is a method of using a peppermint nano emulsion formulation for odor elimination. The method comprises the steps of spraying over the affected area to cover the affected area with the peppermint nano emulsion formulation, optionally repeating the spraying step 2-6 times depending on the severity of the odor, reapplying at least once weekly for 3-4 weeks, and continuing to reapply weekly if odors return. In one embodiment, the method further comprises diluting the nano emulsion formulation before spaying.

In a third aspect, provided herein is a formulation for scent neutralization. The formulation comprises about 1-20 weight percent a scent neutralizing agent, a stabilizer, and a disinfectant, in water in the form of a nano emulsion. In one embodiment, the scent neutralizing agent of the formulation comprises peppermint oil. In another embodiment, the stabilizer of the formulation comprises a detergent or surfactant. In one embodiment, the disinfectant of the formulation comprises benzalkonium chloride. In some embodiments, the formulation further comprises sodium bicarbonate or sodium carbonate. In some embodiments, the formulation further comprises an odor enhancement solvent. In one embodiment, the odor enhancement solvent is peppermint water. In some embodiments, the weight ratio between the scent neutralizing agent and the stabilizer in the formulation is close to one.

In a fourth aspect, provided herein is a method of using a nano emulsion formulation for odor elimination. The method comprises the steps of spraying the affected area with the nano emulsion formulation, optionally repeating the spraying step 2-6 times depending on the severity of the odor, reapplying at least once weekly for 3-4 weeks, and continuing to reapply weekly if odors return. In some embodiments, the method further comprises diluting the nano emulsion formulation before spaying.

In a fifth aspect, provided herein is a method of making a formulation for scent neutralization, the formulation comprises about 1-20 weight percent a scent neutralizing agent comprising peppermint oil, a stabilizer comprising Tween 60 wherein the weight ratio between the peppermint oil and Tween 60 is close or equal to one, about 5 weight percent disinfectant benzalkonium chloride, about 2 weight percent sodium bicarbonate, and about 30 weight percent an odor enhancement solvent that comprises peppermint water, in distilled water in the form of a nano emulsion. The method comprises the steps of mixing the scent neutralizing agent with the surfactant to form an oleic phase, forming an aqueous solution by mixing distilled water, peppermint water, sodium bicarbonate and benzalkonium chloride, and mixing the oleic phase with the aqueous solution with a high-speed homogenizer to form the nano emulsion formulation. In one embodiment, the oleic phase and the aqueous solution are mixed at a speed of at least 20,000 rpm for at least 3 minutes. In one embodiment, the oleic phase and the aqueous solution are mixed at a speed of about 24,000 rpm for about 5 minutes. In one embodiment, the scent neutralizing agent and the surfactant are mixed at a speed of about 600 rpm for about 10 minutes. In one embodiment, the aqueous solution is formed by mixing distilled water, peppermint water, sodium bicarbonate and benzalkonium chloride at a speed of about 600 rpm for about 15 minutes.

### BRIEF DESCRIPTION OF THE DRAWINGS

The drawing figures are not necessarily to scale, and certain features may be shown exaggerated in scale or in a somewhat generalized or schematic form in the interest of clarity and conciseness. For more complete understanding of the features and advantages of the present invention, reference is now made to the detailed description of the invention along with the accompanying figures.

FIG. 1 shows the effect of surfactant type on the droplet size of nano emulsions according to Example 1.

FIG. 2 shows average drop diameter vs observation time for the Tween 60 nano emulsions of Example 1.

FIG. 3 shows turbidity vs observation time for the Tween 60 nano emulsions of Example 1.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a composition or formulation that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Although the examples given herein are for disinfecting and scent neutralization for rodent termination, it should be understood that the formulation disclosed herein can be used for disinfection and scent neutralization for other animals as well, including domesticated animals, such as cats, dogs, etc., livestock (e.g., cattle, horses, pigs, sheep, goats, etc.), laboratory animals (e.g., mouse, rabbit, rat, guinea pig, etc.), birds, other common pets and alike. In some embodiments, the formulation disclosed herein can be used for disinfection and scent neutralization for a mammal such as a primate, for example, a human.

“Amount effective” and “effective amount” in the context of a formulation for disinfection and scent neutralization refers to an amount of the composition or dosage form that produces one or more desired responses in the area treated, for example, in areas that were infested by rodents. Therefore, in some embodiments, an amount effective is any amount of a formulation provided herein that produces one or more of these desired responses. The amount is one that a technician believes to have a benefit for disinfection and scent neutralization of a previously infested area or maintain an area rodent free upon regular treatment.

In some embodiments of any of the formulations and methods provided, the effective amount is one in which the treated area is rodent free, for at least 1 month, at least 2 months, at least 3 months, at least 4 months, at least 5 months, at least 6 months, at least 9 months, at least 1 year, at least 2 years, at least 5 years, or longer.

Effective amount will depend, of course, on the particular area being treated and the severity of a condition; the duration of the treatment; the concentration of the formulation, and the specific method of treatment or application. The effective amount can be 0.1 mL -30 mL per square foot (mL/sqft) of a treated area, for example, 0.1-0.2 mL/sqft, 0.2-0.3 mL/sqft, 0.3-0.4 mL/sqft, 0.4-0.5 mL/sqft, 0.5-0.6 mL/sqft, 0.6-0.7 mL/sqft, 0.7-0.8 mL/sqft, 0.8-0.9 mL/sqft, 0.9-1 mL/sqft, 1-2 mL/sqft, 2-3 mL/sqft, 3-4 mL/sqft, 4-5 mL/sqft, 5-6 mL/sqft, 6-7 mL/sqft, 7-8 mL/sqft, 8-9 mL/sqft, 9-10 mL/sqft, 10-11 mL/sqft, 11-12 mL/sqft, 12-13 mL/sqft, 13-14 mL/sqft, 14-15 mL/sqft, 15-16 mL/sqft, 16-17 mL/sqft, 17-18 mL/sqft, 18-19 mL/sqft, 19-20 mL/sqft, 20-21 mL/sqft, 21-22 mL/sqft, 22-23 mL/sqft, 23-24 mL/sqft, 24-25 mL/sqft, 25-26 mL/sqft, 26-27 mL/sqft, 27-28 mL/sqft, 28-29 mL/sqft, 29-30 mL/sqft, 1.5-25 mL/sqft, 2-20 mL/sqft, 2.5-15 mL/sqft, 3-10 mL/sqft, or 4-7 mL/sqft.

The concentration of the formulation can be between 1-20% peppermint oil concentration, for example, 1-1.5%, 1.5-2%, 2-2.5%, 2.5-3%, 3-3.5%, 3.5-4%, 4-4.5%, 4.5-5%, 5-5.5%, 5.5-6%, 6-6.5%, 6.5-7%, 7-7.5%, 7.5-8%, 8-8.5%, 8.5-9%, 9-9.5%, 9.5-10%, 10-10.5%, 10.5-11%, 11-11.5%, 11.5-12%, 12-12.5%, 12.5-13%, 13-13.5%, 13.5-14%, 14.5-15%, 15-15.5%, 15.5-16%, 16-16.5%, 16.5-17%, 17-17.5%, 17.5-18%, 18-18.5%, 18.5-19%, 19-19.5%, or 19.5-20%.

The area treated by the formulation disclosed herein may need to be retreated in subsequent months at a pre-determined interval between every day to every year, for example, every two days, every three days, every four days, every five days, every six days, every week, every 1.5 week, every two weeks, every 2.5 weeks, every three weeks, every 3.5 weeks, every 4 weeks, every 5 weeks, every 6 weeks, every 7 weeks, every 8 weeks, every 9 weeks, every 10 weeks, every 11 weeks, every 12 weeks, every 13 weeks, every 14 weeks, every 15 weeks, every 16 weeks, every 17 weeks, every 18 weeks, every 19 weeks-every 20 weeks, every 21 weeks, every 22 weeks, every 23 weeks, every 24 weeks, every 25 weeks, every 26 weeks, every 27 weeks, every 28 weeks, every 29 weeks-every 30 weeks, every 31 weeks, every 32 weeks, every 33 weeks, every 34 weeks, every 35 weeks, every 36 weeks, every 37 weeks, every 38 weeks, every 39 weeks, every 40 weeks, every 41 weeks, every 42 weeks, every 43 weeks, every 44 weeks, every 45 weeks, every 46 weeks, every 47 weeks, every 48 weeks, every 49 weeks, every 50 weeks, every 51 week, or every 52 weeks. In some embodiments, a treated area maybe retreated more frequently during the immediate days after the initial treatment followed by longer treatment periods.

Nano emulsion peppermint formulation (the formulation) disclosed herein has been shown to be effective for neutralizing odors and pheromones of rodents after the rodents infested area is cleaned up. Additionally, the formulation disclosed herein has shown to be effective in prevent rodents from re-enter the treated premises. When applied regularly, the formulation disclosed herein has shown to be effective in maintaining the results of rodent elimination from human dwellings. Because the nano emulsions disclosed herein is formulated with sodium bicarbonate and benzalkonium chloride, the formulation disinfects the treated area as well. Other commonly used reagents that are functionally similar to the ingredients in the formulation can be used as replacement as well. For example, instead of sodium bicarbonate, sodium carbonate can be used.

In some embodiments, the formulation disclosed herein may be applied using a sprayer or sprinkler. In some embodiments, the formulation disclosed herein may be applied using a spray bottle. For example, a typical treatment regimen comprises spraying generously over the affected area, covering the entire affected area with a light mist, and reapplying once weekly for 3-4 weeks, continuing to reapply weekly if odors return.

Inactive ingredient such as nonionic surfactants such as Tween 20, and Tween 60 may be used together with the active ingredients such as peppermint oil, peppermint water, sodium bicarbonate and benzalkonium chloride.

Throughout this application, various publications may be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

The present disclosure may be understood more readily by reference to the following detailed description of embodiments and to the Figures and their previous and following description.

As disclosed herein, peppermint containing formulation is used to neutralize rodent pheromones. The nano emulsion formulation may include peppermint oil, peppermint water, or a combination thereof. The nano emulsion formulation is believed to have increased efficiency at relatively low peppermint ingredient concentrations. When combined with sodium bicarbonate and benzalkonium chloride, the nano emulsion formulation disclosed herein can not only neutralize odors but also disinfect the treated area.

### EXAMPLES

### Example 1

### Nano Emulsion Peppermint Formulation

### 1. Reagents Materials

Peppermint oil obtained through a steam drag distillation process
Peppermint water from steam drag distillation process
Nonionic surfactants (Tween 20, and Tween 60) purchased from Sigma Aldrich
Sodium Bicarbonate (Baking soda) purchased from Sigma Aldrich
Benzalkonium Chloride purchased from Clariant
Double-distilled water was used for preparing the nano emulsions

### 2. Equipment

Homogenizer Caframo
High-speed homogenizer, ultraturrax t25
Analytical balance Mettler Toledo
Steam carry distillation equipment
50, 100, 250 and 500 ml Beakers
Oven
Particle diameter meter, Malvern model Nanosizer ZS
Turbidimeter, Hach model 2100P

A series of nano emulsions were prepared by varying using a series of stabilizers until a stable product of good appearance and smell was obtained, which can then be diluted in water and applied by means of sprinklers in the treated area.

The final formulation combines peppermint oil, peppermint water, sodium bicarbonate, benzalkonium chloride and tween 60.

Emulsion preparation

Nano emulsions with 10% of peppermint oil concentration were prepared using a high-speed homogenizer (ultraturrax T25) at 24000 rpm for 5 minutes. This concentration served as the basis for the investigation and will be used as a concentrated solution that can be subsequently diluted for final application.

First, the oleic phase was prepared by mixing the peppermint oil with the surfactant at 600 rpm for 10 minutes in the homogenizer. In the next step, the aqueous phase was prepared by mixing distilled water, peppermint water, sodium bicarbonate and benzalkonium chloride at 600 rpm for 15 minutes. Finally the oleic phase was added dropwise to the aqueous phase with continuous mixing at 24000 rpm for 5 minutes using the high-speed homogenizer.

Characterization

The nano emulsions obtained were characterized by measuring the drop diameter in the nanosizer and subsequently turbidity was measured to determine the clarity of the product obtained. All samples remained under observation at room temperature for 18 days to study their stability.

Results

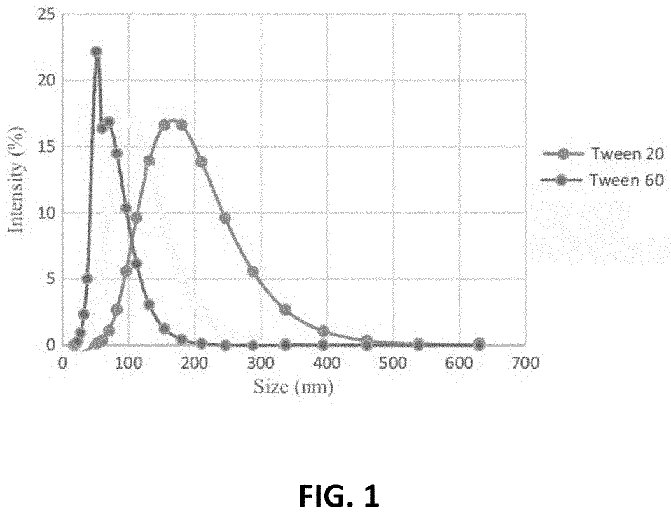

Two surfactants tween 20 and tween 60 were used to prepare the nano emulsions and the resulting nano emulsions are measured using the particle diameter meter and the measured results are shown in FIG. 1. As shown in FIG. 1, Tween 60 nano emulsion showed better results, resulting in a nano emulsion with a particle diameter of 71 nm while tween 20 gives an emulsion with an average diameter of 166 nm, which is not as good as the tween 60 emulsion.

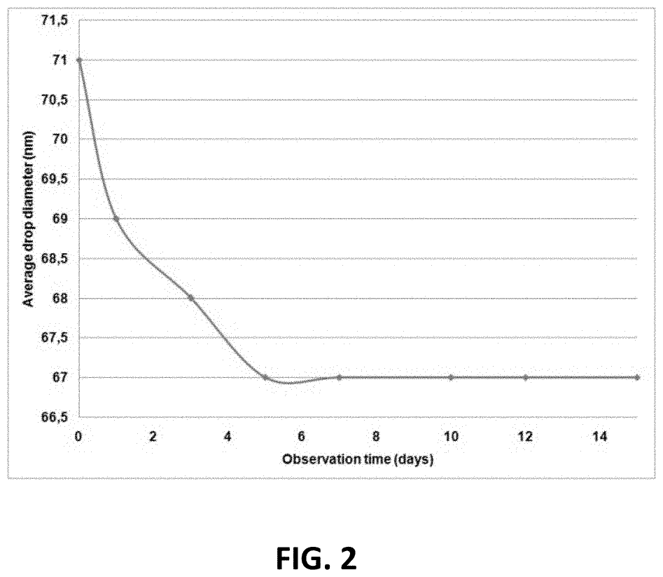

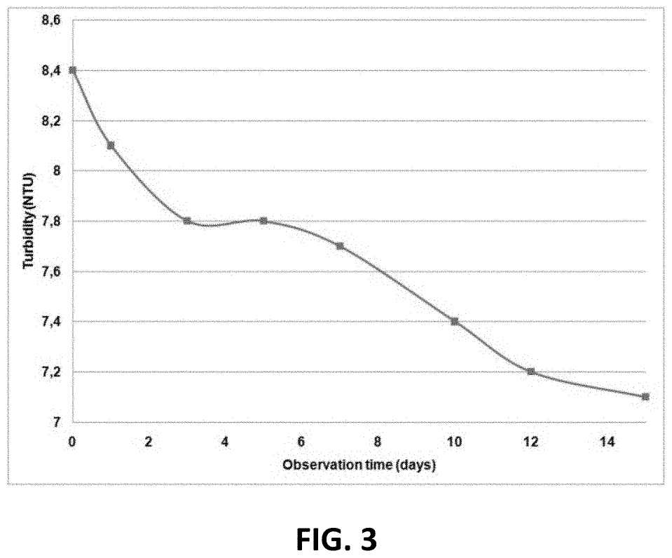

The stability of the Tween 60 nano emulsion was measured through the study of turbidity and particle diameter for an interval of 18 days, which results showing for turbidity and particle diameter in FIG. 3 and FIG. 2, respectively. The average drop diameter of the nano emulsions obtained varied little during the time evaluated, which means that the product obtained is stable. As for the turbidity, the nano emulsions obtained were clarifying day by day, and that is evident in the decrease in turbidity during the period evaluated (see FIG. 3). The Tween 60 nano emulsion therefore is a stable product with good visual appearance, low viscosity, and fresh peppermint smell.

The composition of an example 100 mL Tween 60 nano emulsion at 10% of peppermint oil concentration is shown in Table 1.

TABLE 1

| | % | |
|---|---|---|
| Component | (weight) | Function |
| Peppermint Oil | 10* | Active agent |
| Tween 60 | 10 | Stabilizer |
| Peppermint water | 30 | Odor Enhancement |
| | | Solvent |
| Sodium Bicarbonate | 2 | Odor adsorbent |
| Benzalkonium Chloride | 5 | disinfectant |
| Double-distilled water | 43 | Solvent |

In some embodiments, when preparing for commercial product, 5% and 2% peppermint oil formulations can be made with the composition of these formulations shown in Tables 2 and 3, respectively.

TABLE 2

| | % | |
|---|---|---|
| Component | (weight) | Function |
| Peppermint Oil | 5* | Active agent |
| Tween 60 | 5 | Stabilizer |
| Peppermint water | 30 | Odor Enhancement |
| | | Solvent |
| Sodium Bicarbonate | 2 | Odor adsorbent |
| Benzalkonium Chloride | 5 | disinfectant |
| Double-distilled water | 53 | Solvent |

TABLE 3

| | % | |
|---|---|---|
| Component | (weight) | Function |
| Peppermint Oil | 2* | Active agent |
| Tween 60 | 2 | Stabilizer |
| Peppermint water | 30 | Odor Enhancement |
| | | Solvent |
| Sodium Bicarbonate | 2 | Odor adsorbent |
| Benzalkonium Chloride | 5 | disinfectant |
| Double-distilled water | 59 | Solvent |

Three formulations with different peppermint oil content were obtained, which can be used by the client with optional final adjustments. In some embodiments, the disinfectant, Benzalkonium Chloride, content is equal or close to 5% by weight, the sodium bicarbonate content is equal or close to 2%, and the content of the stabilizer (tween 60) is equal or close to that of the peppermint oil used.

### Example 2

### Nano Emulsion Peppermint Formulation Application to Eliminate Rodent Odor

The nano emulsion peppermint formulation of Example 1 is combined with water in an application spray bottle. Area of the premise where rodent has been removed or eliminated is sprayed using the application spray bottle. Depending on the severity of odor, the area is sprayed 2 to 6 times to eliminate the odor.

The embodiments above are intended to be illustrative and not limiting. Additional embodiments are within the claims. In addition, although the present disclosure has been described with reference to particular embodiments, those skilled in the art will recognize that changes can be made in form and detail without departing from the spirit and scope of the disclosure. Any incorporation by reference of documents above is limited such that no subject matter is incorporated that is contrary to the explicit disclosure herein.

We claim:

1. A formulation for scent neutralization, comprising,
about 1-20 weight percent a scent neutralizing agent comprising peppermint oil;
a stabilizer comprising Tween 60 wherein the weight ratio between the peppermint oil and Tween 60 is close or equal to one; and
about 5 weight percent disinfectant benzalkonium chloride,
in distilled water in the form of a nano emulsion.

2. The formulation of claim 1, further comprising about 2 weight percent sodium bicarbonate.

3. The formulation of claim 1, wherein further comprising about 30 weight percent an odor enhancement solvent that comprises peppermint water.

4. A method of using a nano emulsion formulation for eliminating odor, the method comprising:
spraying over the affected area to cover the affected area with the nano emulsion formulation of claim 1;
optionally repeating the spraying step 2-6 times depending on the severity of the odor;
reapplying at least once weekly for 3-4 weeks, and
continuing to reapply weekly if odors return.

5. The method of claim 4, further comprising diluting the nano emulsion formulation before spaying.

6. A formulation for scent neutralization, comprising,
about 1-20 weight percent a scent neutralizing agent;
a stabilizer; and
a disinfectant;
in water in the form of a nano emulsion.

7. The formulation of claim 6, wherein the scent neutralizing agent comprises peppermint oil.

8. The formulation of claim 6, wherein the stabilizer comprises a detergent or surfactant.

9. The formulation of claim 6, wherein disinfectant comprises benzalkonium chloride.

10. The formulation of claim 6, further comprising sodium bicarbonate.

11. The formulation of claim 6, wherein further comprising an odor enhancement solvent.

12. The formulation of claim 11, wherein the odor enhancement solvent is peppermint water.

13. The formulation of claim 6, wherein the weight ratio between the scent neutralizing agent and the stabilizer is close to one.

14. A method of using a nano emulsion formulation for odor elimination, the method comprising:
spraying over the affected area to cover the affected area with the nano emulsion formulation of claim 6;
optionally repeating the spraying step 2-6 times depending on the severity of the odor;
reapplying at least once weekly for 3-4 weeks; and
continuing to reapply weekly if odors return.

15. The method of claim 14, further comprising diluting the nano emulsion formulation before spaying.

16. A method of making a formulation for scent neutralization, the formulation comprising,
about 1-20 weight percent a scent neutralizing agent comprising peppermint oil;
a stabilizer comprising Tween 60 wherein the weight ratio between the peppermint oil and Tween 60 is close or equal to one;
about 5 weight percent disinfectant benzalkonium chloride;
about 2 weight percent sodium bicarbonate; and
about 30 weight percent an odor enhancement solvent that comprises peppermint water,
in distilled water in the form of a nano emulsion,
the method comprising:
mixing the scent neutralizing agent with the surfactant to form an oleic phase;
forming an aqueous solution by mixing distilled water, peppermint water, sodium bicarbonate and benzalkonium chloride; and
mixing the oleic phase with the aqueous solution with a high-speed homogenizer to form the nano emulsion formulation.

17. The method of claim 16, wherein the oleic phase and the aqueous solution are mixed at a speed of at least 20,000 rpm for at least 3 minutes.

18. The method of claim 16, wherein the oleic phase and the aqueous solution are mixed at a speed of about 24,000 rpm for about 5 minutes.

19. The method of claim 16, wherein the scent neutralizing agent and the surfactant are mixed at a speed of about 600 rpm for about 10 minutes.

20. The method of claim 16, wherein the aqueous solution is formed by mixing distilled water, peppermint water, sodium bicarbonate and benzalkonium chloride at a speed of about 600 rpm for about 15 minutes.
